(19) United States
(12) Patent Application Publication
(10) Pub. No.: US 2008/0243919 A1
(43) Pub. Date: Oct. 2, 2008

(54) Method of and Control Arrangement For Providing Information About Food and Everages in Combination With Audio/Video Contents

(75) Inventor: Paul Ullmann, Vienna (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,282

(22) PCT Filed: Apr. 20, 2005
(86) PCT No.: PCT/IB05/51287

§ 371 Date: Oct. 25, 2006

(30) Foreign Application Priority Data
Apr. 29, 2004 (EP) 04101838.3

(51) Int. Cl. G06F 17/00

(52) U.S. Cl. 707/104.1; 707/E17.009

(57) ABSTRACT

A method of providing information about food and/or beverages in combination with audio/video contents, comprises the provision of a database (DB) in which an audio/video identifier (ID) identifying the audio/video content is correlated with food/beverage information (SI) about foods/beverages to be associated with individual scenes/events in the audio/video content and about the times (TC) at which the foods/beverages occur in the audio/video content, the transmission of an audio/video identifier (ID) to the database (DB) by means of a control arrangement (1), the determination by the database (DB) of food/beverage information (SI) associated with the audio/video identifier (ID) and the transmission back to the control arrangement (1) of the food/beverage information (SI) that has been determined, and the triggering of an event for the display of the food/beverage information and/or for the preparation of food/beverages in accordance with instructions contained in the food/beverage information.

### FIELD OF THE INVENTION

The invention relates to a method of providing information about food and/or beverages in combination with audio/video contents.

The invention also relates to a control arrangement for providing information about food and beverages in combination with audio/video contents.

### BACKGROUND OF THE INVENTION

From patent document US 2001/0048641 is known a scent emitting device, which device has a playback device and a special playback cassette containing a recording, such as, for example, a playback cassette pre-recorded with music, films, etc. The playback cassette also includes a number of cartridges holding scents stored therein and the playback device includes scent dispersal apparatus. The recording on the playback cassette in turn includes inaudible control signals, which control signals cause the scent dispersal apparatus to emit scents into the atmosphere from given scent cartridges. The purpose of this known playback device is to implement a kind of “scented cinema” that is intended to be attractive not only to the human senses of sight and hearing but also to the olfactory sense.

It is true that this known playback device does reveal an approach to offering listeners and viewers a more all-encompassing experience than stimulus merely of the senses of sight and hearing when taking in audio and video contents, but the additional stimulus to which it is confined is that of the olfactory sense. Something that is problematic in this case is that, although a space can very quickly be filled with scents, it is extremely difficult to remove the scents again from the space quickly, unless one wishes to expose the listener or viewer to strong draughts. Use of the known playback device will therefore result, in a short time, in a mixture of many sorts of scents becoming established in the space in which it is operating, which mixture will be found by the listener or viewer to be a nuisance because of its stimulant effect. Therefore, when films are being watched or, in more general terms, when audio and video contents of any kind are being taken in, there is still a need to provide the consumer with a comprehensive experience that appeals to the human senses in ways that go beyond the direct stimulus provided for the senses of hearing and sight, and hence to ensure that the sensory experience is maximized. The merit of the inventor is to have recognized that there is a particular requirement for the aural and visual experience to be expanded in such a way that the human sense of taste too is stimulated. Evidence of this requirement can for example be seen in principle from the enormous amounts of popcorn and lemonade consumed by cinema audiences. However, the consumption of random foods and beverages, and particularly snacks, is still not the right way of expanding the aural and visual experience in the desired manner, and the viewer will only have the intended comprehensive experience as a result of consuming specific foods and beverages that are related to the content of a film or video, thus causing him to identify to a certain degree with what is happening in the film or video.

### OBJECT AND SUMMARY OF THE INVENTION

It is an object of the invention to provide a method of the kind specified in the first paragraph above and a control arrangement of the kind specified in the second paragraph above by which the aims specified above are achieved.

To enable the object stated above to be achieved, features according to the invention are provided in a method according to the invention, thus enabling a method according to the invention to be characterized in the manner stated below, namely:

A method of providing information about food and/or beverages in combination with audio/video contents, comprising the provision of a database in which an audio/video identifier identifying the audio/video content is correlated with food/beverage information about foods/beverages to be associated with individual scenes/events in the audio/video content and about the times at which the foods/beverages occur in the audio/video content, the transmission of an audio/video identifier to the database by means of a control arrangement, the determination by the database of food/beverage information associated with the audio/video identifier and the transmission back to the control arrangement of the food/beverage information that has been determined, and the triggering of an event for the display of the food/beverage information and/or for the preparation of food/beverages in accordance with instructions contained in the food/beverage information.

To enable the object stated above to be achieved, features according to the invention are provided in a control arrangement according to the invention, thus enabling a control arrangement according to the invention to be characterized in the manner stated below, namely:

A control arrangement for providing information about food and/or beverages in combination with audio/video contents, which audio/video contents can be identified from an audio/video identifier, the control arrangement having communications means for transmitting the audio/video identifiers to a database and for receiving food/beverage information from the database in response to the audio/video identifiers transmitted, the food/beverage information containing information about foods/beverages to be associated with individual scenes/events in the audio/video content and about the times at which the foods/beverages occur in the audio/video content, and the control arrangement being arranged to operate an audio/video device to display the food/beverage information and/or to operate a device for preparing food/beverages in accordance with instructions contained in the food/beverage information.

What is achieved by virtue of the features according to the invention is that people are offered a comprehensive experience when taking in audio/video contents and, as they do so, not only are they stimulated to gain aural and visual enjoyment, but their sense of taste is stimulated too although, in contrast to the mere buying of snacks before seeing a film in a cinema, there is a relationship between the audio/video contents and the information about food and beverages that is provided. In particular, the listeners/viewers are informed of foods and beverages that are suited to the audio/video contents and are given, if required, instructions on obtaining and preparing them in good time, or the information provided can be used to automatically control devices for preparing food/beverages, or to generate orders and transmit them to a supplier of food/beverages so that the latter can supply the food and beverages ordered in good time. What in particular is achieved by the provisions made in accordance with the invention, is that viewers of a film are in a position to consume the same foods and beverages as the persons acting in a film at the same time as the latter are doing so. The viewers can thus feel themselves to be part of the scene in the film and as a result of this interaction with what is happening in the film can experience the film more intensely than was possible hitherto.

It may be mentioned that to date only a few attempts have been made to set up a correlation between food and beverages and the experience of taking in audio/video contents. In this way, there are cinemas that offer a brunch followed by the showing of a film. There has also been the development of meal-and-a-show combinations where for example an evening meal is offered in combination with a variety performance. Open-air cinemas often have various restaurants around the cinema space itself. However, all these approaches are of a non-technical nature and, what is more, have the disadvantage that there is no connection between the food and beverages offered and the content of the film. Similarly, with the known approaches there is little temporal synchronization between the consumption of the food and beverages and the events in the film. Finally, these known approaches are confined to public entertainment facilities and are not applicable to private homes.

Under the provisions made in claims 2 and 11, the advantage is obtained that allowance is made in the database for the information needed by the devices, to enable instructions specific to the devices to be included in the food/beverage information, such as, for example, the heating-up time of food with due allowance for the power of the particular device.

Under the provisions made in claims 3 and 12, the advantage is obtained that the food/beverage information can be precisely attuned to the consumer's preferences and for example only meatless foods can be included.

Under the provisions made in claim 4, the advantage is obtained that by means of instructions contained in the food/beverage information, audio/video devices and/or food/beverage preparing devices can be controlled automatically, thus enabling the user to concentrate on the audio/video contents without being distracted by having to operate audio/video devices and/or food/beverage preparing devices.

Under the provisions made in claim 5, the advantage is obtained that ordering information is generated automatically, thus relieving the consumer of this task.

Under the provisions made in claim 6, the advantage is obtained that, for example, suppliers of convenience foods matched to the audio/video contents can enter information to this effect on the database over the data network. Because suppliers of this kind are interested, for purely commercial reasons, in offering a comprehensive range and in adding the appropriate information to the database, this will produce a comprehensive database that is kept up to date properly.

Under the provisions made in claims 7 and 13, the advantage is obtained that access to the database is almost universally available because the majority of households now have a connection to the internet available to them.

Under the provisions made in claims 8 and 14, the advantage is obtained that a stand-alone solution can be implemented. It is likewise possible for manufacturers of databases of this kind to make them available to their customers on a data carrier, in which case the production and distribution of the database may for example take place on a subscription basis or may be financed by advertising.

Under the provisions made in claims 9 and 17, the advantage is obtained that the control arrangement can be incorporated in existing units in order in this way to extend the functions of the latter.

Under the provisions made in claim 15, the advantage of technically straightforward implementability is obtained, there already being existing standards for the readable audio/video identifiers mentioned, as a result of which widespread acceptance can be assumed.

Under the provisions made in claim 16, the advantage of extremely simple operation is obtained, and the possibility of mistakes being made can be ruled out.

These and other aspects of the invention are apparent from and will be elucidated with reference to the embodiments described hereinafter.

### BRIEF DESCRIPTION OF THE DRAWINGS

In the drawings:

FIG. 1 shows a system for performing the method according to the invention for providing information about food and/or beverages in combination with audio/video contents.

FIG. 2 shows an illustrative layout for the database used in the invention.

### DESCRIPTION OF EMBODIMENTS

In the description below, the pair of words “audio/video” will be abbreviated to “AV”. Also, for easier reading, the pair of words “food/beverages” will be shortened to “food” or “foods”, the term “food” or “foods” being understood to include beverages as well.

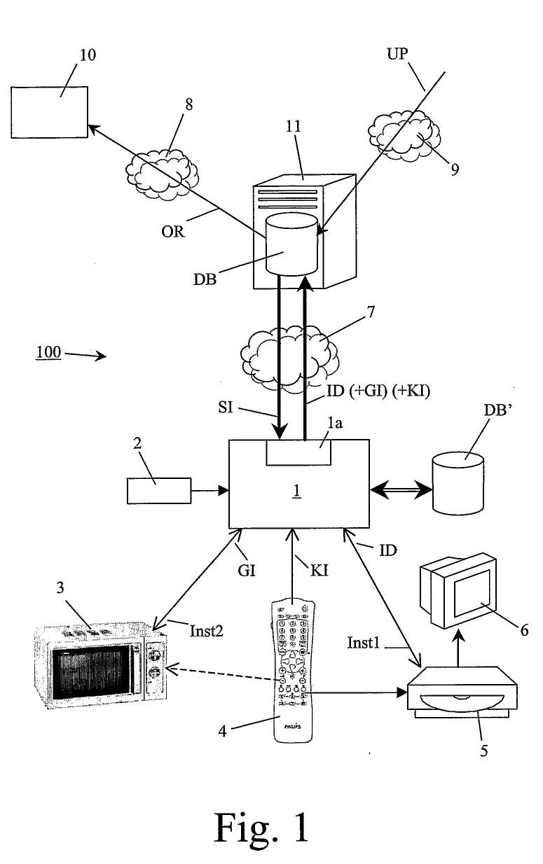

FIG. 1 shows, in the form of a schematic block circuit diagram, an embodiment of a system 100 for performing the method according to the invention for providing information about food and/or beverages in combination with AV contents. The system 100 comprises a database DB that runs on a computer 11, and a control arrangement 1 that is arranged to transmit an AV identifier ID, via communications means 1a and a data network 7, such as the internet for example, to the database DB. For the database DB, the AV identifier ID that is received represents an inquiry, which inquiry is answered by determining the food information SI associated with the AV identifier ID and transmitting the information back to the control arrangement 1 over the data network 7. The control arrangement 1 is also in communication with a food/beverage preparing device 3 (referred to for short below as a food preparing device 3), which food/beverage preparing device 3 is in the form of a microwave oven in the present case, with a remote-control means 4, referred to below for short as a remote control 4, and with an audio/video device 5, such as a DVD player for example, which audio/video device 5 displays video information on a screen 6. It should be mentioned that the AV device 5 may also take the form of a DVD recorder, of a device that plays back AV contents from a hard disk, or of a device that downloads AV contents from a data network and plays them back. The control arrangement 1 also communicates with food scanning means 2, which food scanning means 2 preferably have a barcode reading means or a reading means for reading contactless data carriers, which data carriers or bar code is used for marking the food.

In what follows, the carrying out of the method according to the invention on the system 100 will be described, it being assumed by way of example that the control arrangement 1 is built into the AV device 5, which latter is in the form of a DVD player, and that the database DB is available in the form of an internet web service. The database DB is accessible to producers of instant meals for updating purposes, which producers offer foods and beverages suited to certain AV contents, though the database DB can also be updated with alternative options, e.g. meatless, non-alcoholic, kosher, etc.

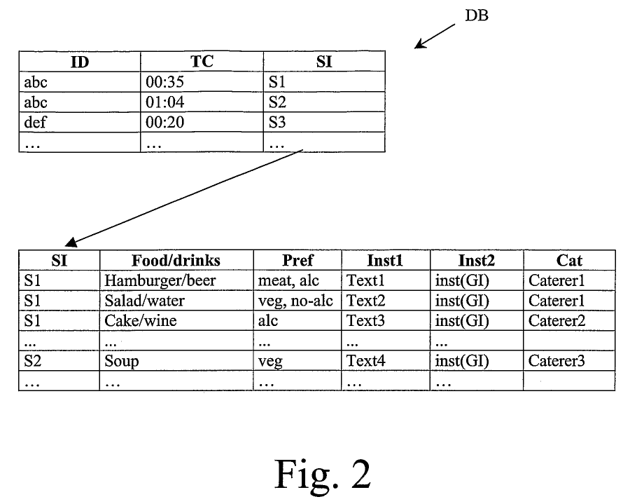

The layout of the database DB is shown in FIG. 2. In the database DB, an AV identifier ID that identifies an AV content, such as a film for example, is correlated with food information SI on foods associated with individual scenes/events in the AV content and on the times at which the foods occur in the AV content. The food information SI contains various suggestions for foods that vary to suit users' preferences Pref, and instructions Inst1 for texts to be displayed in association with the foods, and also control instructions Inst2, which control instructions Inst2 are in turn a function of items of device information GI, as will be explained in detail below. The database DB also contains entries Cat on the possible suppliers of various foods and beverages. A consumer identifies an AV content, for instance a film, contained on a DVD by inserting the DVD in the DVD player 5. Pressing a given key or making a sequence of entries on the remote control 4 causes a code characteristic of the AV content on the DVD to be read out and transmitted to the database DB over the internet as an AV identifier ID. The database DB then determines food information SI and transmits it back to the control arrangement 1 built into the DVD player 5. Depending on the content of the food information SI, special instructions are displayed on the screen 6 for the consumer, such as, for example, “Prepare cold beer”, “Place convenience meal XY in microwave oven”. He should carry out these instructions before the film starts, so as not to be distracted during the film. As optional information, the time in the film is shown at which the preparing or serving of the food and beverages should begin so that the consumer is able to eat the same dishes at the same time as the actors in the film. In addition or as an alternative to the display of the timing information included in the food information, it may be used by the control arrangement 1 to program the food preparing device 3, such as the microwave oven mentioned in which a convenience meal had previously been placed. The food preparing device 3 too may have a control arrangement 1 (or certain of the functions of the latter) built into it so that it can for example transmit to the database DB important device parameters relating to itself that affect the time needed to prepare food, thus enabling it to receive in return appropriate control data (instructions Inst2). In accordance with the invention, provision is also made for a scanning means to be connected to the food preparing device 3, so that the contents of an instant meal can be read out or checked by reference to its barcode on the packaging or to a contactless data carrier contained in the packaging. It goes without saying that, rather than an integrated control arrangement being used to program the food preparing device 3, use may also be made of a remote control arrangement, which remote control arrangement communicates with the food preparing device 3 via a data link, such as, for example, a Bluetooth, telephone or infrared link. The food preparing device 3 and the AV device 5 may communicate in the same way via the data links mentioned.

The consumer may use the remote control 4 to specify certain preferences in relation to food and beverages, for example “No meat”, “No alcohol”, “Vegetarian”. These preferences are matched up in the database DB with the suggested food that is best suited to them.

In one embodiment of the method according to the invention, provision is made for the consumer to be able to order from a catering service, automatically or at least partly automatically, foods that are suited to an AV content, by sending consumer information KI giving name, address. etc. to the database DB, which database DB generates an automatic order OR if there is a suitable match between food that is suited to a given AV content and the consumer's preferences, and sends it to a food supplier 10. The order OR also includes timing information, for example the food supplier knows when delivery has to take place if the food is to be ready for the consumer at his home at the intended time and if he is to be able to eat it in agreement with the AV content.

In general, it can be said that any food information SI transmitted by the database DB to the control arrangement 1 triggers in the control arrangement 1 an event that depends on the content of the food information SI received. This event may on the one hand be the display of information for a user, which is done by the control arrangement 1 transmitting appropriate instructions Inst1, which are either contained in the food information SI itself or can be extracted therefrom by the control arrangement 1, to an AV device 5, such as a DVD player, where the instructions Inst1 are converted into video signals for display on a screen 6. The event may, on the other hand, equally well be the direct actuation of a food preparing device 3, such as, for example, a microwave oven or an ice-making device, etc., which is done by the control arrangement 1 transmitting appropriate instructions Inst2, which are either contained in the food information SI itself or can be extracted therefrom by the control arrangement 1, to the food preparing device 3, to operate the latter, as a function of time, to prepare food and/or beverages. For this purpose, it is useful if either the food preparing device 3 is itself capable of transmitting device-specific device information GI to the database DB, on the basis of which the database DB determines appropriate instructions Inst2, includes them in the food information SI and transmits the latter to the control arrangement 1, or if the control arrangement 1 is capable of requesting appropriate device information GI from the food preparing device 3 and passing it on to the database DB. As an alternative to this, the control arrangement 1 may be arranged to receive appropriate device information GI from a user, in which case the input of data may for example be performed via a remote control 4. The remote control 4 is usefully in the form of a universal remote control so that the AV device 5 too and, if required, even the food preparing device 3 can be controlled with it. In a preferred embodiment of the invention, provision is also made for the control arrangement 1 to transmit consumer information KI to the database DB, which consumer information KI can be entered by a user via the remote control 4. It is preferable for the consumer information KI that has been entered to be stored in the control arrangement 1 so that the consumer only has to enter it once. The consumer information KI may for example include the user's preferences such as meatless food, no alcoholic beverages, etc. and may be used in the database DB to specify the food information SI more accurately.

In an embodiment of the method according to the invention, provision is further made for the database DB to generate ordering information OR from the AV identifier ID received and the consumer information KI, which consumer information KI should, in this case, include the address of the consumer, and to transmit the ordering information OR to a food supplier 10 over the data network 8, which food supplier 10 deals with the order by delivering the appropriate foods to the consumer. Provision is also made for the database DB to be updatable over a data network 9, as indicated by an arrow UP in FIG. 1. The data networks 8, 9 may for example be the internet.

As well as for communication between the control arrangement 1 and the database DB over the data network 7, provision may be made for the control arrangement 1 to be so arranged as to communicate locally with a database DB′, which database DB′ is a copy of the database DB. Provision may be made in this case for the database DB′ to be loaded into the control arrangement 1 over the data network 7, and operated in it, locally. As an alternative to this, the database DB′ may be made available to the control arrangement 1 on a data carrier, such as, for example, on CD, DVD, semiconductor memory, etc.

It should be mentioned that the control arrangement 1 may either take the form of a stand-alone unit or alternatively may be built into the AV device 5 and/or the food/beverage preparing device 3 and/or the remote control unit 4. The control arrangement 1 may also be arranged to read AV identifiers stored on AV data carriers. This can easily be done if the control arrangement 1 is built into the AV device 5, because in this case recourse may be had to the AV playback circuits in the AV device 5. If for example the AV device is in the form of a DVD player, the unique identifier that each DVD has can be read and used as an AV identifier.

A further embodiment of the control arrangement 1 comprises food scanning means 2, which food scanning means 2 preferably have a barcode reading means or a reading means for reading contactless data carriers. The scanning means 2 may also be, used to read AV identifiers from cassettes or from packaging of AV data carriers.

1. A method of providing information about food and/or beverages in combination with audio/video contents, comprising the provision of a database (DB) in which an audio/video identifier (ID) identifying the audio/video content is correlated with food/beverage information (SI) about foods/beverages to be associated with individual scenes/events in the audio/video content and about the times (TC) at which the foods/beverages occur in the audio/video content, the transmission of an audio/video identifier (ID) to the database (DB) by means of a control arrangement (1), the determination by the database (DB) of food/beverage information (SI) associated with the audio/video identifier (ID) and the transmission back to the control arrangement (1) of the food/beverage information (SI) that has been determined, and the triggering of an event for the display of the food/beverage information (SI) and/or for the preparation of food/beverages in accordance with instructions contained in the food/beverage information (SI).

2. A method as claimed in claim 1, wherein the control arrangement (1) transmits to the database (DB) device information (GI) relating to food/beverage preparing devices (3) that can be used

3. A method as claimed in claim 1, wherein the control arrangement (1) transmits consumer information (KI) to the database (DB).

4. A method as claimed in claim 1, wherein the food/beverage information (SI) comprises instructions (Inst1, Inst2) for the operation of audio/video devices and/or food/beverage preparing devices.

5. A method as claimed in claim 3, wherein the database (DB) generates ordering information (OR) both from the audio/video identifier (ID) received and from the consumer information (KI) and transmits the ordering information (OR) over a data network (8) to a food/beverage supplier (10).

6. A method as claimed in claim 1, wherein the database (DB) can be updated over a data network (9).

7. A method as claimed in claim 1, wherein the control arrangement (1) communicates with the database (DB) over a data network (7).

8. A method as claimed in claim 1, wherein the database (DB′) can be loaded into the control arrangement (1) and operated therein.

9. A method as claimed in claim 1, wherein the control arrangement (1) is built into an audio/video device (5) and/or a food/beverage preparing device (3) and/or a remote-control unit (4).

10. A control arrangement (1) for providing information about food and/or beverages in combination with audio/video contents, which audio/video contents are able to be identified from an audio/video identifier (ID), the control arrangement having communications means (1a) for transmitting the audio/video identifiers (ID) to a database (DB) and for receiving food/beverage information (SI) from the database in response to the audio/video identifiers (ID) transmitted, the food/beverage information (SI) containing information about food/beverages to be associated with individual scenes/events in the audio/video content and about the times (TC) at which the foods/beverages occur in the audio/video content, and the control arrangement (1) being arranged to operate an audio/video device (5) to display the food/beverage information (SI) and/or to operate a device (3) for preparing food/beverages in accordance with instructions (Inst1, Inst2) contained in the food/beverage information (SI).

11. A control arrangement as claimed in claim 10, wherein the control arrangement is arranged to determine or receive device information (GI) relating to food/beverage preparing devices that can be used, and to transmit the device information (GI) to the database (DB).

12. A control arrangement as claimed in claim 10, wherein the control arrangement is arranged to receive consumer information (KI) and to transmit it to the database (DB).

13. A control arrangement as claimed in claim 10, wherein the communications means (1a) are arranged to communicate with the database (DB) over a data network (7).

14. A control arrangement as claimed in claim 10 that is arranged to cause the database (DB′) to be loaded and run locally.

15. A control arrangement as claimed in claim 10 that is arranged to read audio/video identifiers stored on audio/video data carriers.

16. A control arrangement as claimed in claim 10, also comprising food/beverage scanning means (2) that preferably comprise a barcode reading means or a reading means for reading data carriers able to be read without contact.

17. A control arrangement as claimed in claim 10, wherein the control arrangement (1) is built into an audio/video device (5) and/or a food/beverage preparing device (3) and/or a remote-control unit (4).
